(19) United States
(12) Patent Application Publication
(10) Pub. No.: US 2003/0002478 A1
(43) Pub. Date: Jan. 2, 2003

(54) Lightweight internet protocol telephony client

(76) Inventors: Hani El-Gebaly, Beaverton, OR (US); Stephen Ing, Beaverton, OR (US); Mitu Aggarwal, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/895,291

(22) Filed: Jun. 29, 2001

(51) Int. Cl. H04J 3/16

(52) U.S. Cl. 370/352; 370/465; 370/401

(57) ABSTRACT

An Internet Protocol (IP) telephony system includes a lightweight stimulus client configured to receive user input requesting an IP telephony service (e.g., an ITU-T H.450 supplementary service) and communicate the received input over a packet-based network using a standard call control protocol (e.g., Media Gateway Control Protocol or ITU-T H.248). A call agent, executing on a remote server connected to the packet-based network, is configured to perform the requested IP telephony service based on the received input.

### BACKGROUND

The present application describes systems and techniques relating to Internet Protocol (IP) telephony and more particularly to a lightweight client application for IP telephony.

IP telephony enables allows callers to use a packet-switched network, such as the Internet, as the transmission medium for making telephone calls. As shown in FIG. 1, an IP telephony client application 101 (a software application program executing on a computer platform such as a PC) converts a user's voice signals into digital format, encapsulates the digitized voice data into IP packets, which are then transmitted via a communication link 100 to a network 103, such as a LAN (local area network) or WAN (wide area network). Depending on the identity of the called party, the IP packets containing the digitized voice data can be delivered either to another client application 102 connected to the network 103, or to a conventional telephone handset 106 connected to the Public Switched Telephone Network (PSTN) 105 via a gateway 104.

### DRAWING DESCRIPTIONS

FIG. 1 is a block diagram of a typical network configuration that supports IP telephony.

FIG. 2 shows an example of a typical user interface presented by an IP telephony client.

FIG. 3 is a block diagram of an IP telephony network configuration including a stimulus client and a feature server.

FIG. 4 is a block diagram showing details of a stimulus client and a call agent.

FIG. 5 is a flowchart of a procedure for launching and using an IP telephony stimulus client.

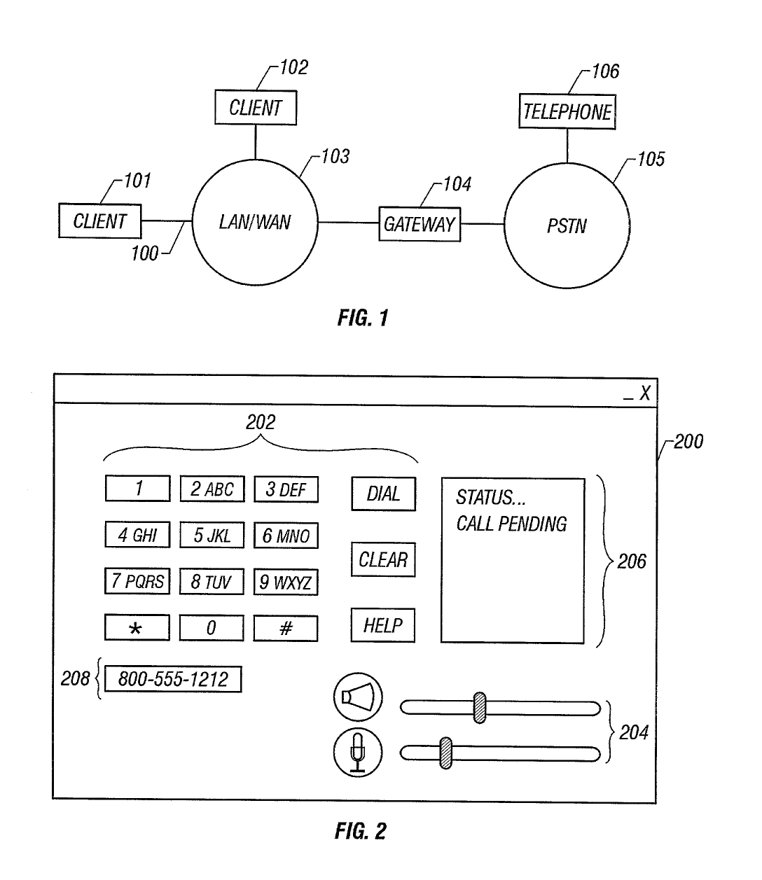

Details of one or more embodiments are set forth in the accompanying drawings and the description below. Other features, objects, and advantages will be apparent from the description and drawings, and from the claims.

### DETAILED DESCRIPTION

FIG. 2 shows an example of a user interface for a typical IP telephony client. As shown, the user interface is presented to the user in a display window 200 and includes graphical controls 202 (e.g., buttons as shown) that enable the user to provide input to the client, for example, a telephone number to be dialed, or a command such as “dial,” “clear,” etc. Other graphical controls 204 (e.g., sliders as shown) enable the user to control functions such as microphone input and/or speaker output levels. The user interface typically also includes display areas 206 and 208 to provide textual and/or graphical feedback to the user regarding information such as the number being dialed, call status, and the like.

Prior to using an IP telephony client, a user typically first must visit a website associated with a client vendor or other software distributor, download the client application (usually about a megabyte or larger in size) to the user's computer, and then install the client application. This procedure typically results in a static copy of the client application residing on the user's computer system. Once installed, the user can make calls by executing and interacting with the IP telephony client, which in turn typically communicates with a IP telephony server residing elsewhere in the network using a proprietary (e.g., non-standard) protocol to provide IP telephony service.

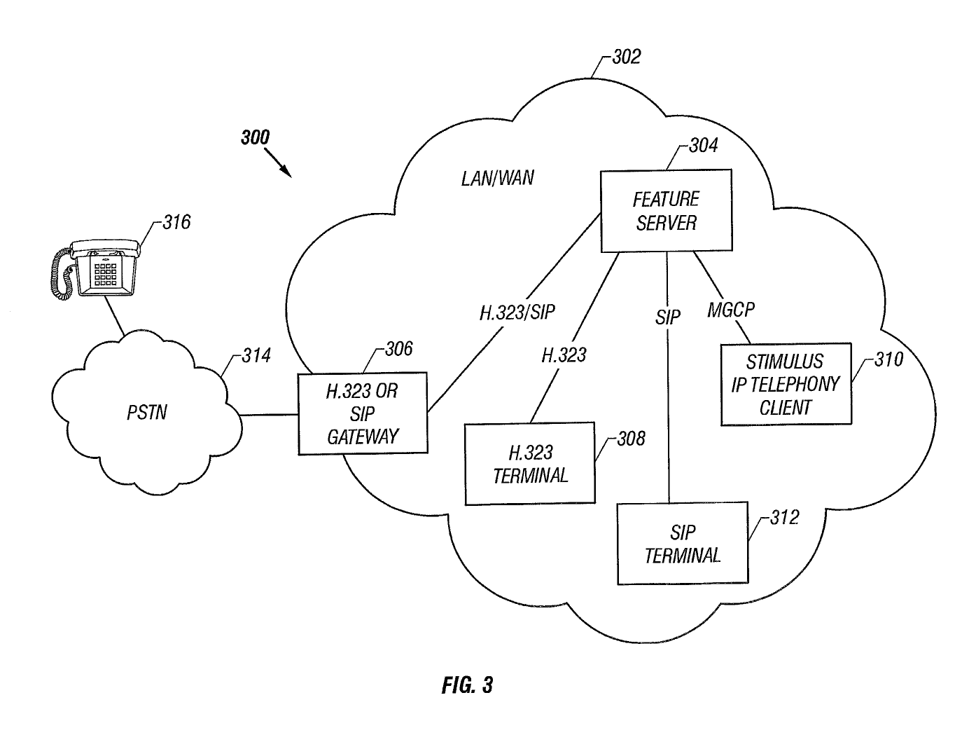

FIG. 3 is a block diagram of an IP telephony network configuration 300 that implements a “stimulus”-based IP telephony client 310, residing on a user's computer platform, in communication with a feature server 304 to provide enhanced IP telephony functionality. As used herein, a stimulus client may be one that provides very little, if any, functionality locally but rather passes through input from a user to a remote server, which in turn provides the requested functionality. The stimulus client may communicate with the server by means of “stimulus signaling.” Put another way, a stimulus client may be one that acts as a stimulus that causes the server to provide functionality requested by a user at the client. By moving the software infrastructure that provides the bulk of the functionality to the server side, a stimulus client can be made “lightweight”—that is, very small in size—while still providing the user with a rich and robust feature set.

As shown in FIG. 3, the stimulus client 310 and the feature server 304 reside within a packet-based network 302. The feature server 304 is a functional entity that uses stimulus signaling to provide an endpoint with additional features not available locally at the endpoint. An example of a feature server implementation is described in International Telecommunication Union (ITU-T) H.323 Annex L: Packet-Based Multimedia Communications Systems (March 2001).

The feature server 304 can communicate not only with the stimulus client 310 but also with other IP telephony endpoints within the packet-based network (e.g., terminal 308 or terminal 312) and/or via gateway 306 with endpoints such as telephone 316 in the PSTN 314. The feature server 304 is able to communicate with endpoints using any of various standard call control protocols including the ITU-T H.323 protocol, the Session Initiation Protocol (SIP) as defined in Request For Comment (RFC) number 2543 (March 1999) of the Internet Engineering Task Force (IETF), the Media Gateway Control Protocol (MGCP) as defined in IETF RFC number 2705 (October 1999), and the ITU-T H.248 protocol (also known as the “Megaco” protocol). In the example shown in FIG. 3, the feature server 304 communicates with the stimulus client 310 using MGCP signaling and with terminals 308, 312 using H.323 and SIP signaling, respectively. However, other configurations may use different or additional protocols for communicating between the feature server and endpoints depending on the objectives of the system designer, administrator and/or end-users.

In a typical application, the stimulus client 310 would receive input from a user through a user interface such as depicted in FIG. 2. For example, if the user entered a telephone number to be dialed by clicking appropriate buttons in the dialpad portion of graphical controls 202, the stimulus client 310 would collect the entered digits and transmit them as DTMF (dual tone multi-frequency) data to the feature server 304, which in turn would establish a connection with the called endpoint. Alternatively, or in addition, a user at the client could request one or more supplementary services by entering appropriate numbers on the dialpad, which would be collected by the client 310 and passed on to the feature server 304, which in turn would provide the requested functionality. A supplementary service is defined as any telephony service over and above basic “plain old telephone service” (POTS), which is limited to making and receiving calls. Examples of supplementary services include call transfer, call forwarding, hold, voice-mail, call-waiting, 3-way conferencing, and the like.

As an example, a user who already had established a call could request that the call be transferred to a different endpoint by dialing a predetermined sequence (e.g., *9) followed by the number of the endpoint to which the call is to be transferred. The stimulus client 310 would collect the dialed sequence and transmit corresponding DTMF data to the feature server 304, which in response would perform the requested call transfer by rerouting the IP packets containing voice data to the transfer destination endpoint. In general, the stimulus client 310 and the feature server 304 can cooperate in this manner to provide a user with any standard supplementary service (for example, as defined in ITU-T H.450) or with any non-standard supplementary service that a telephony service entity may wish to provide.

The use of a lightweight stimulus client that communicates with a feature server using a standard protocol, such as shown in FIG. 3, may provide several advantages. For example, because the stimulus client provides little or no telephony services locally, but rather passes on telephony service requests to be fulfilled by the feature server remotely, the stimulus client can be made very small, for example, on the order of 30 kilobytes as opposed to the roughly 1 megabyte or larger used for conventional telephony clients. In particular, the size of the stimulus client's stack (the software code, typically implemented as dynamically linked libraries (DLLs), that are invoked to provide telephony services) can be kept to a bare minimum. A small client stack size may be desirable both to client vendors and to end-users—client vendors tend to like it because a small stack generally simplifies development, maintenance and distribution of client applications and end-users tend to like it because of dramatically reduced client download times. Indeed, as a result of its small size, downloading of the stimulus client can appear to end-users as being virtually instantaneous. In contrast, a download of a large-stack client—typically about 1 megabytes or larger—can take several minutes, especially when the user has a standard telephone-line connection that is limited to 56 Kbps or slower. Consequently, users are likely to be much less resistant to downloading the stimulus client because doing so entails little or no waiting time.

Moreover, the lightweight client may be advantageous from the perspective of client vendors because, in view of the minimal download time, users are much more likely to download and use the most current version of the client. In fact, use of a stimulus client coupled to a feature server can reduce the size of the client to an extent that it becomes practical for the client to be downloaded dynamically, and transparently from the user's perspective, with each new instantiation. In that case, each user is guaranteed to use the most recent version of the client. Consequently, software development and maintenance costs can be reduced dramatically because a lightweight client vendor would no longer have to worry about version control or compatibility with earlier versions. At the same time, because each use of the client may involve a dynamic download and instantiation of the client, client vendors can more easily and continuously (or frequently) improve or upgrade the client to provide users with cutting-edge functionality. Further, dynamically downloading the client with each use allows client vendors to more easily keep track of user and usage statistics.

Other advantages may arise as a result of the stimulus client's support and use of standard IP telephony protocols such as MGCP, H.248, SIP and H.323. For example, in contrast to a conventional IP telephony client, which typically communicates with the server using a proprietary protocol, the stimulus client can communicate with the feature server using MGCP or H.248. The feature server in turn can communicate with other endpoints and network entities using SIP and/or H.323. Consequently, the stimulus client and the feature server are able to interoperate with any IP telephony endpoint or service provider that uses standard protocols. For example, by collecting DTMF data from an end-user and passing it on to the feature server, the stimulus client can provide the end-user with a full-range of supplementary services such as defined in H.450.

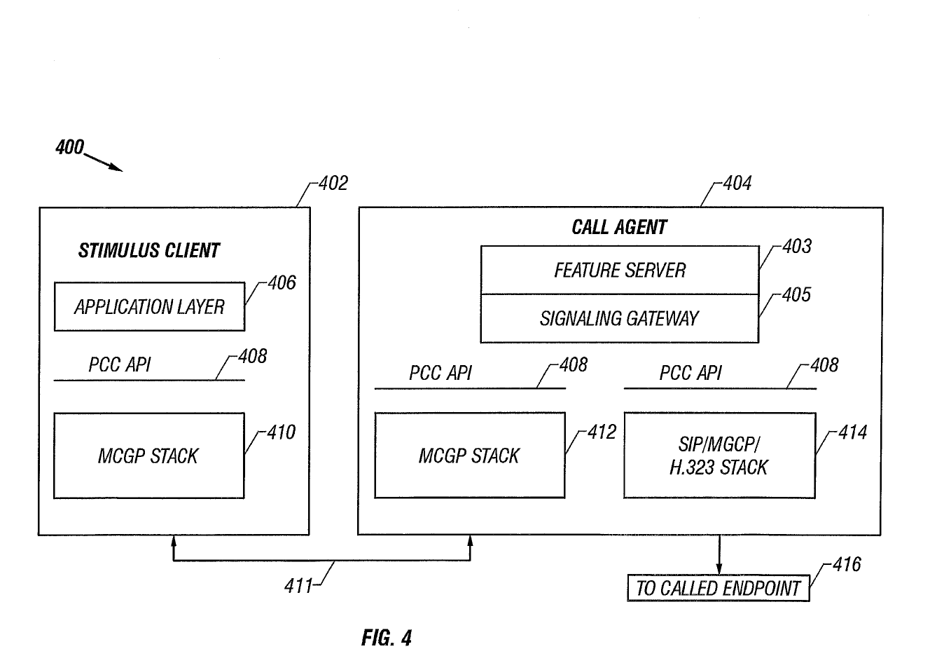

FIG. 4 is a block diagram showing details of a stimulus client configuration 400 in which the stimulus client 402 communicates with a call agent 404 using a standard IP telephony protocol (e.g., MGCP or H.248) over communication link 411. The stimulus client 402 has two basic components: an application layer 406, which represents the software layer that interacts with the end-user to present a user interface, collect DTMF information and the like, and a MGCP stack 410, which is the set of software routines that facilitates MGCP-based communications with the call agent 404. The application layer 406 communicates with the MGCP stack 410 through a plugable call control (PCC) application program interface (API) 408. The PCC API 408 allows a single client application to place calls through multiple protocols utilizing a single, common API.

More particularly, the PCC API 408 exposes a common set of function calls, properties, and callbacks that can be used with any of several different call control protocols such as MGCP, H.248, SIP and H.323. It is preferable that the PCC API 408 exposes the fewest possible number of parameters for each function call so as to provide the simplest usage model for the default call model. Examples of common function calls, properties, and callbacks that may be exposed by PCC API 408 include (1) listening for incoming calls, (2) placing calls, (3) answering calls, (4) hanging up calls, (5) capability selection, negotiation and renegotiation, (6) security (authentication, integrity), (7) call hold, (8) mute, (9) establishing multi-point conferences, merging multiple conferences into one, (10) splitting a conference into two, (11) transferring with and without consultation, (12) overlapped sending and dialing, (13) sending DTMF signals, (14) multi-line/multi-call/multi-station appearance, (15) park/pickup calls, (16) redirect/forward calls, and (17) out-of-band service commands.

The call agent 404 is a server-side application that includes a feature server 403, a signaling gateway 405, one or more stacks 412-414 for communicating with endpoints such as stimulus client 402 and/or called endpoint 416, and a PCC API 408 for each different stack instantiation 412-414. The signaling gateway 405 serves as a signaling front-end to the feature server 403 to enable the feature server 403 to communicate with endpoints using different signaling protocols such as SIP, MGCP, H.248 and H.323. As shown in FIG. 4, the call agent 404 includes a separate MGCP stack 412 for communicating with MGCP-based endpoints such as the stimulus client 402. Similarly, the call agent 404 would include a separate stack 414 (e.g., SIP, H.323, H.248 or MGCP) for each different protocol type that is to be used.

The feature server 403 can provide services, such as H.450 supplementary services or non-standard services, to the stimulus client 402. The stimulus client 402 uses MGCP signaling to send DTMF digits to the feature server 403, which translates the DTMF digits into specific supplementary services. Thus, the supplementary service functionality is moved into the feature server 403 and the stimulus client 402 can be implemented as a very lightweight client.

For example, the feature server 403 can use the PCC API 408 to place or transfer a call between the MGCP-based stimulus client 402 and another endpoint 416 (e.g., either MGCP-, H.248-, H.323-, or SIP-based) on the other end. If the other endpoint 416 is, for example, an H.323 endpoint, the feature server 403 can provide inter-working between MGCP and H.450 supplementary services. In that case, the feature server 403 implements the desired supplementary service and behaves as the endpoint for all H.450 operations.

The feature server 403 also can use stimulus signaling to control various user interface elements at the stimulus client 402. Examples of this include providing hardware-independent indications for message waiting or line lamps, writing to a text display, receiving user input such as digits, text, and so on.

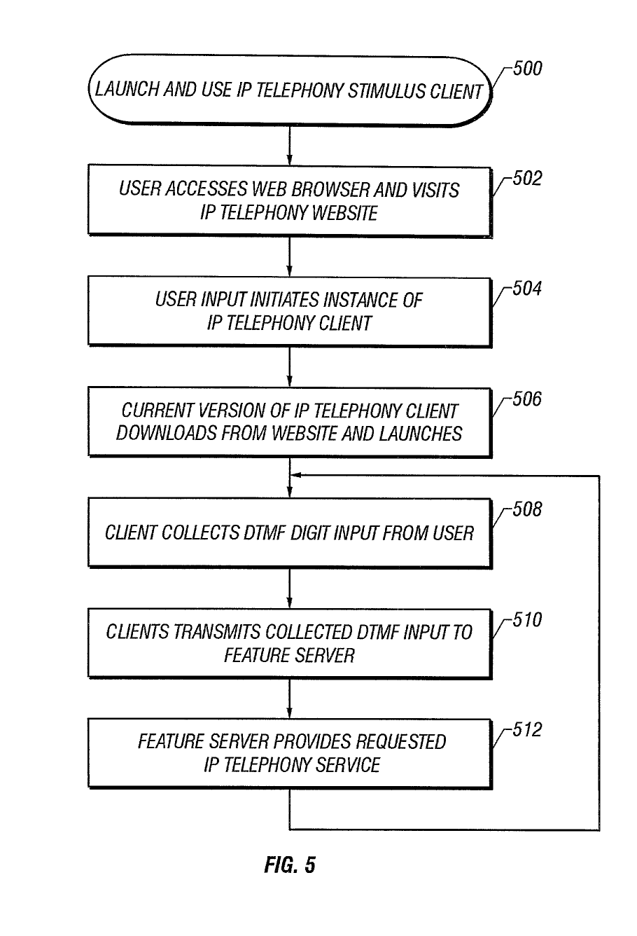

FIG. 5 is a flowchart of a procedure 500 for launching and using an IP telephony stimulus client. First, a user accesses a web browser application and visits a URL (uniform resource locator) address associated with an IP telephony website (e.g., an IP telephony client vendor or service provider website) (502). Next, input received from a user, for example, by clicking a button or a link, initiates an instance of an IP telephony client (504). In other words, the user gives an indication by mouse click or otherwise that usage of the IP telephony client is desired.

Alternatively, the user could have previously downloaded and stored on the computer platform locally a small, dedicated application whose primary, or sole, purpose is to download the most recent version of the IP telephony client stored at a specified URL. In that case, the user would not need to access a web browser to use the client, but rather could, for example, simply double-click on a desktop icon corresponding to the dedicated download application.

In response to the user's indication that usage of the IP telephony client is desired, the current version of the IP telephony client downloads from the website and launches (506), for example, presenting the user with a user interface similar to that shown in FIG. 2. The client can be implemented as a Java applet that downloads and is executed locally by a virtual machine (VM) on the user's computer platform. Other implementations of the client can use interpreted or scripting languages such as PERL, TCL or the like, in which a client script (a set of commands to be interpreted and performed locally) is downloaded and executed locally on the user's computer platform. As discussed above, the size of the stimulus client to be downloaded can be made small enough that the download appears to be virtually instantaneous, or even completely transparent, to the user.

Next, the client collects DTMF digit input from the user indicating that the user desires access to a supplementary service such as voice-mail or the like (508). The client then transmits the collected DTMF input to the feature server, for example, using the MGCP or H.248 protocols (510). In response, the feature server provides the requested service, for example, by using standard protocols (SIP, MGCP, H.323, H.248) to communicate with another endpoint such an IP telephony voice-mail system and thereby acting as an intermediary between the stimulus client and the voice-mail system endpoint (512). Procedures 508-512 can be repeated as desired to provide the user with access to additional or different supplementary services.

Various implementations of the systems and techniques described here may be realized in digital electronic circuitry, integrated circuitry, specially designed ASICs (application specific integrated circuits) or in computer hardware, firmware, software, or combinations thereof.

Other embodiments may be within the scope of the following claims.

What is claimed is:

1. A system comprising:
a stimulus client configured to receive user input requesting an Internet Protocol (IP) telephony service and communicate the received input over a packet-based network using a standard call control protocol;
a call agent, executing on a remote server connected to the packet-based network, configured to perform the requested IP telephony service based on the received input.

2. The system of claim 1 in which the stimulus client comprises an application layer configured to communicate with an end-user and a call control protocol stack configured to communicate with the call agent using the standard call control protocol.

3. The system of claim 2 in which the stimulus client's call control protocol stack comprises a Media Gateway Control Protocol (MGCP) stack.

4. The system of claim 2 in which the stimulus client's call control protocol stack comprises an ITU-T H.248 stack.

5. The system of claim 2 in which the application layer comprises a user interface having a plurality of graphical controls.

6. The system of claim 1 in which the received user input comprises Dual Tone Multi-Frequency (DTMF) input.

7. The system of claim 1 in which the call agent comprises:
a feature server configured to provide telephony services to telephony endpoints;
a signaling gateway configured to facilitate communication between the feature server and one or more endpoints; and
one or more call control protocol stacks configured to facilitate signaling between the call agent and the one or more endpoints.

8. The system of claim 7 in which the feature server is capable of providing supplementary services to one or more endpoints.

9. The system of claim 8 in which the supplementary services comprise ITU-T H.450 supplementary services.

10. The system of claim 7 in which the feature server provides non-standard telephony services to one or more endpoints.

11. The system of claim 7 in which one or more call control protocol stacks comprise one or more of a Media Gateway Control Protocol (MGCP) stack, an ITU-T H.248 stack, a Session Initiation Protocol (SIP) stack, and an ITU-T H.323 stack.

12. A client application comprising:
an application layer configured to receive Dual Tone Multi-Frequency (DTMF) input corresponding to a requested Internet Protocol (IP) telephony service; and
a call control protocol stack configured to communicate the received DTMF input to a feature server over a packet-based network using a standard call control protocol.

13. The application of claim 12 in which the application layer comprises a user interface having a plurality of graphic controls for receiving user input.

14. The application of claim 12 in which the call control protocol comprises a Media Gateway Control Protocol (MGCP).

15. The application of claim 12 in which the call control protocol comprises an ITU-T H.248 protocol.

16. The application of claim 12 in which the application includes substantially no software infrastructure for performing IP telephony services locally.

17. The application of claim 12 in which the application comprises a set of interpreted commands.

18. The application of claim 17 in which the application comprises an applet performed by a virtual machine.

19. A method comprising:
in response to receiving user input requesting initiation of Internet Protocol (IP) telephony service, downloading and launching an IP telephony client application;
receiving at the IP telephony client input from a user identifying a telephony service;
communicating the received input to a feature server; and
based on the communicated input, performing the identified telephony service at the feature server.

20. The method of claim 19 in which the received user input comprises Dual Tone Multi-Frequency (DTMF) input.

21. The method of claim 19 in which downloading and launching an IP telephony client application comprises transparently downloading, from a user's perspective, a set of commands to be interpreted and performed by a process executing on a computer platform associated with the user.

22. The method of claim 21 in which the set of commands comprises an applet to be performed by a virtual machine executing on the computer platform associated with the user.

23. The method of claim 19 in which the IP telephony client communicates with the feature server using a standard call control protocol.

24. Computer software, embodied in a computer-readable medium and/or a propagated carrier signal, comprising instructions for a computer system to perform the following:
present a telephony user interface that includes graphical controls for receiving input from a user;
receive from a user Dual Tone Multi-Frequency (DTMF) input corresponding to a requested IP telephony service; and
communicate the received DTMF input to a feature server over a packet-switched network using a standard call control protocol.

25. The software of claim 24 further comprising instructions to receive information from the feature server and use the received information to control elements of the telephony user interface.

26. The software of claim 24 in which the standard call control protocol comprises a stimulus protocol.

27. The software of claim 24 in which the standard call control protocol comprises a Media Gateway Control Protocol (MGCP).

28. The software of claim 24 in which the standard call control protocol comprises an ITU-T H.248 protocol.

29. The software of claim 24 in the instructions to communicate the received DTMF input to the feature server comprise a call control protocol stack.

30. The software of claim 24 further comprising instructions to receive user input requesting initiation of Internet Protocol (IP) telephony service and, in response to the received user input, download and launch an IP telephony client application.
